(19) United States
(12) Patent Application Publication
(10) Pub. No.: US 2005/0115077 A1
(43) Pub. Date: Jun. 2, 2005

(54) Eze Ladle and Eze Spatula

(76) Inventor: Thomas John Rauber, Dansville, NY (US)

Correspondence Address: THOMAS JOHN RAUBER, 6050 VISTA HILL, DANSVILLE, NY, 14437, US

(21) Appl. No.: 10/724,592

(22) Filed: Dec. 1, 2003

(51) Int. Cl. A47J 43/28

(52) U.S. Cl. 30/142; 30/324; 294/8

(57) ABSTRACT

We have always had spatulas and ladles. They were simple in structure. My invention allows the user to handle the ladle and spatula with greater control, less effort and greater efficiency.

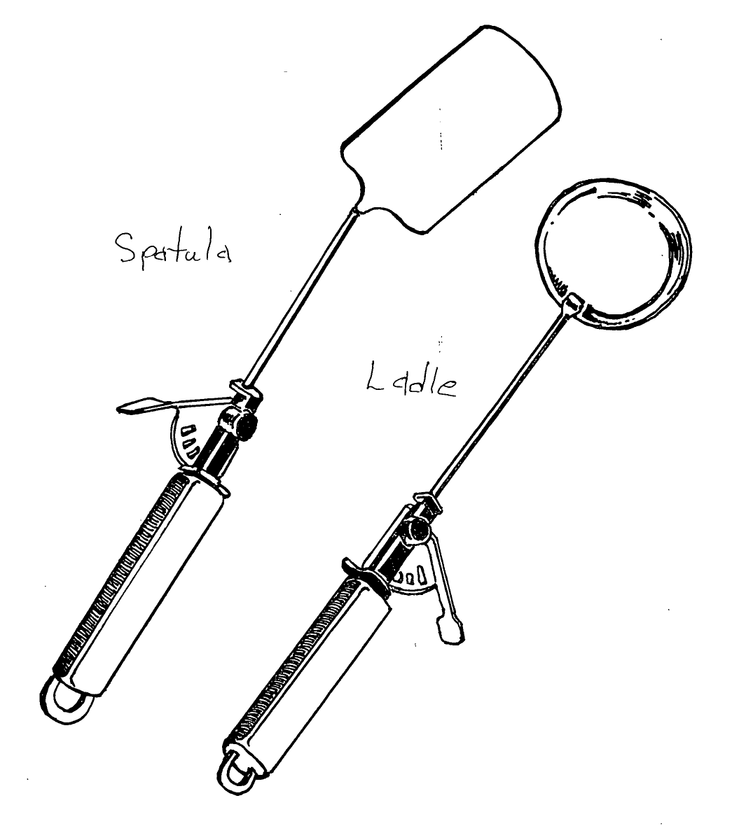

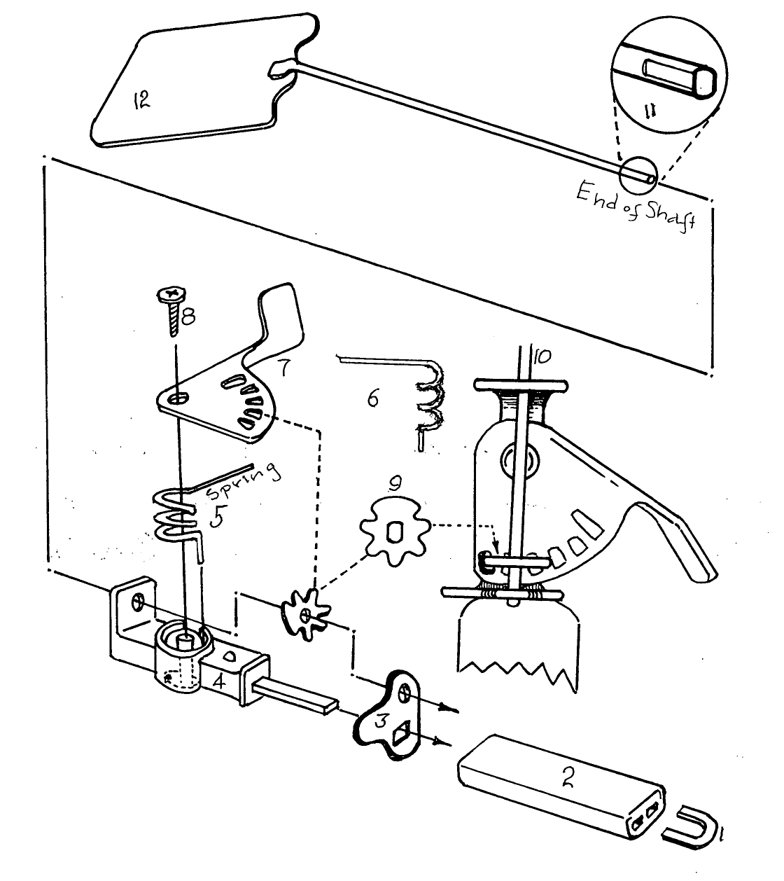

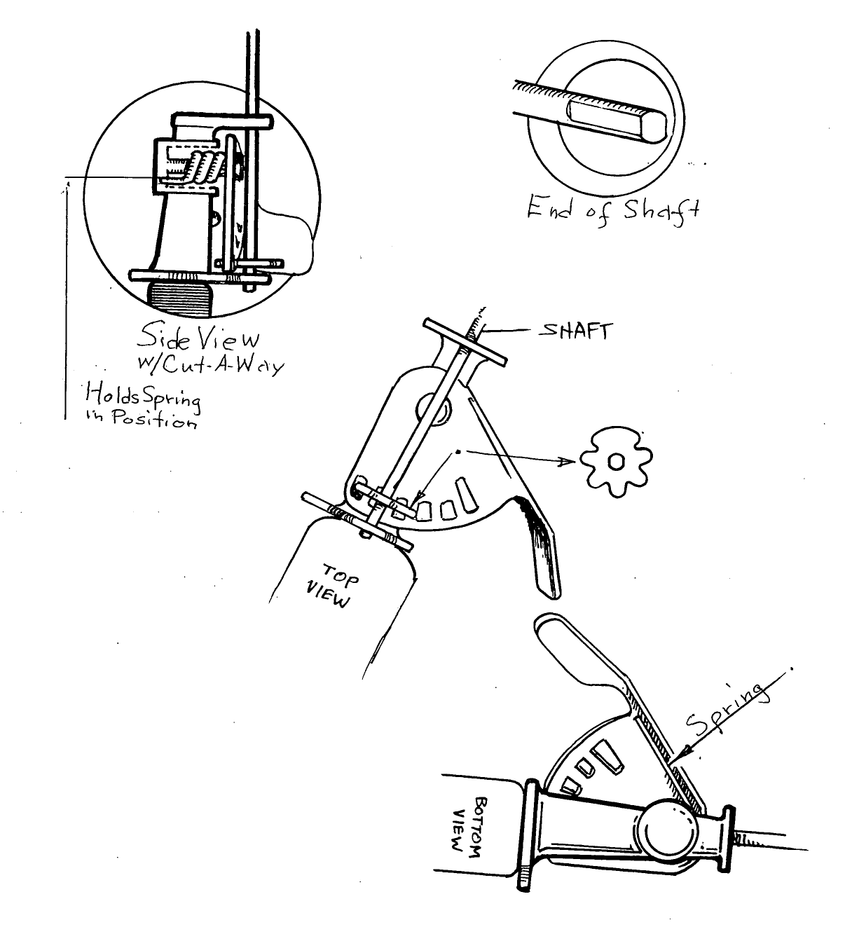

The invention will include 2 tools that use the same principle in their operation. No. 1 is a Ladle and No. 2 is a Spatula. The principle used in operating both 1 and 2 is that by holding the Ladle or Spatula by the handle and pressing the operating lever the Ladle can turn over to the Left; the Spatula can turn over to the Right. A coiled spring (shown in the drawing) under the thumb lever allows the Ladle or Spatula to return when the lever is released. The coiled springs differ in that they are built in reverse of one another allowing the action to be to the right or to the left. When viewing the spatula the thumb lever is to the left allowing movement to the right; viewing the Ladle the thumb lever is to right allowing movement to the left. (Refer to Sheet 1 of 3). Both the Ladle and Spatula will provide more efficiency in the preparation and serving of the food. I have a working model of each. The drawings will give you a better understanding of their operation.

### EXPLANATION OF DRAWINGS

### Description of Parts

1. Hanger Bracket
2. Handle
3. Support for each end of shaft
4. Frame, spring holder, cogs and thumb operation
5. Spring controlling movement to the Right and Return
6. Spring controlling movement to the Left and Return
7. Operating lever, cogs for rolling sprocket to ride on
8. Screw that holds spring and operating lever together
9. Sprocket that controls EZE Spatula and Ladle movement
10. Shaft at the end has a Spatula or a Ladle
11. End of shaft has two flat surfaces holding and locking sprocket in place
12. Spatula or Ladle

1. What I claim as my invention is that the Ladle and Spatula allow the user to press on the thumb attachment allowing the movement to the left or to the right as showed in the drawings. The spatula will move to the right; the ladle will move to the left. The spatula would allow the food on it to be turned over to the left or right. The liquid in the ladle could be poured either to the left or the right for greater ease, control and efficiency in the preparation and presenting of food.
